(19) United States
(12) Patent Application Publication
(10) Pub. No.: US 2008/0296452 A1
(43) Pub. Date: Dec. 4, 2008

(54) SUPPORTING DEVICE AND DISPLAY APPARATUS HAVING THE SAME

(75) Inventor: Jin-sung Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwons-si (KR)

(21) Appl. No.: 12/045,171

(22) Filed: Mar. 10, 2008

(30) Foreign Application Priority Data
May 30, 2007 (KR) 2007-52940

(51) Int. Cl. F21V 21/00

(52) U.S. Cl. 248/222.11

(57) ABSTRACT

A supporting device of a display apparatus, including a stationary base, a moving base to cooperate with the stationary base, a first coupling unit coupled to the stationary base and the moving base to guide the moving base to move with respect to the stationary base along a first plane, and a second coupling unit coupled to the stationary base and the moving base to movably guide the moving base with respect to the stationary base along a second plane substantially vertical to the first plane, the second coupling unit comprising a rotation hinge to rotatably guide the moving base along a transverse direction axis of the first plane.

### CROSS-REFERENCE TO RELATED APPLICATIONS

This application claims priority from Korean Patent Application No. 10-2007-0052940, filed on May 30, 2007 in the Korean Intellectual Property Office, the disclosure of which is incorporated herein by reference in its entirety.

### BACKGROUND OF THE INVENTION

1. Field of the Invention

The present general inventive concept relates to a supporting device and a display apparatus having the same, and more particularly to a supporting device having an improved configuration to adjust a viewing angle of the display apparatus.

2. Description of the Related Art

A display apparatus displaying an image includes a monitor, a television, a projector, etc. The display apparatus includes a video projecting device including a light source unit, a display element converting light emitted from the light source unit into an image, etc., and displays the image formed by the video projecting device on a screen, etc.

The display apparatus may have various supporting devices for adjusting a viewing angle of a formed screen to be conveniently used by a user.

Accordingly, a supporting device and a display apparatus having the same may be provided, enabling a user to more conveniently adjust a viewing angle of a screen.

### SUMMARY OF THE INVENTION

The present general inventive concept provides a supporting device and a display apparatus having the same to conveniently adjust a viewing angle of the display apparatus.

The present general inventive concept also provides a supporting device and a display apparatus having the same to simplify a connection with a peripheral device, and to rapidly change a connection configuration.

The present general inventive concept also provides a supporting device and a display apparatus having the same to improve an external appearance of the display apparatus and to improve space utilization of an installation place.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing a supporting device, including a stationary base, a moving base to cooperate with the stationary base, a first coupling unit coupled to the stationary base and the moving base to guide the moving base to move with respect to the stationary base along a first plane, and a second coupling unit coupled to the stationary base and the moving base to movably guide the moving base with respect to the stationary base along a second plane substantially vertical to the first plane, the second coupling unit including a rotation hinge to rotatably guide the moving base along a transverse direction axis of the first plane.

The first coupling unit and the second coupling unit may be folded in one of an inward direction and an outward direction.

At least one of the first coupling unit and the second coupling unit may be capable of being folded inwardly and outwardly.

The first plane may include one of a horizontal plane and a vertical plane, and the second plane may include the other of the horizontal plane and the vertical plane.

The first coupling unit may include a left coupling unit coupled to first sides of the stationary base and the moving base, and a right coupling unit coupled to second sides of the stationary base and the moving base.

The left coupling unit and the right coupling unit may respectively include a first hinge coupled to the stationary base, a first joint coupled to the moving base, and a first central hinge interposed between the first hinge and the first joint.

The rotation hinge may be coupled to the moving base, and the second coupling unit may include a second hinge coupled to the stationary base, and a second central hinge interposed between the rotation hinge and the second hinge.

The first and second hinges and/or the first and second central hinges may further include a friction member to inhibit inadvertent movement of the moving base with respect to the stationary base.

The first and second hinges and/or the first and second central hinges may be electrically driven.

The rotation hinge may include one of a ball joint and a universal joint.

The foregoing and/or other aspects and utilities of the present general inventive concept can also be achieved by providing a display apparatus, including a display main body, and a supporting device coupled to the display main body to support the display main body, wherein the supporting device includes a stationary base, a moving base to cooperate with the stationary base, a first coupling unit coupled to the stationary base and the moving base to guide the moving base to move with respect to the stationary base along a first plane, and a second coupling unit coupled to the stationary base and the moving base to movably guide the moving base with respect to the stationary base along a second plane substantially vertical to the first plane, the second coupling unit including a rotation hinge to rotatably guide the moving base along a transverse direction axis of the first plane.

The foregoing and/or other aspects and utilities of the present general inventive concept can also be achieved by providing a supporting device, including a stationary base to mount to an installation surface, a moving base to mount to a display screen, a first coupling unit having left and right hinge arrangements coupled between the stationary base and the moving base to guide the display screen along a transverse axis with respect to the installation surface, and to pivot the display screen about a vertical axis substantially perpendicular to the transverse axis, and a second coupling unit having another hinge arrangement coupled between the stationary base and the moving base to pivot the display screen about a horizontal axis substantially perpendicular to the transverse axis.

The first and second coupling units can be adjusted concurrently or independently to adjust a viewing angle of the display screen.

The supporting device may further include a workspace disposed between the stationary base and the moving base to allow a user to change a connection configuration of an external device connected to the display screen.

The supporting device may further include a driving unit to drive the first and second coupling units to adjust a viewing angle of the display screen.

The driving unit may include an electric motor under the control of a controller to electronically adjust the viewing angle of the display screen.

The foregoing and/or other aspects and utilities of the present general inventive concept can also be achieved by providing a supporting device, including a first base supportable to a stationary surface, a second base supportable to a display unit, and a coupling system connecting the first and second base such that the second base can rotate about two axes orthogonal to each other and can move along a third axis orthogonal to both the first and second axes.

The coupling system may include a first coupling unit to rotate the second base about one of the two rotatable orthogonal axes, and to move the second base along the third orthogonal axis, and a second coupling unit to rotate the second base about the other rotatable orthogonal axis.

The first coupling unit may include a pair of hinge arrangements disposed on opposite sides of the first and second bases, respectively, and the second coupling unit may include a hinge arrangement disposed on a top or bottom surface of the first and second bases.

At least one of the hinge arrangements may include a stationary member to maintain a position of the second base with respect to the first base.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, in which:

FIG. 1 is a perspective view illustrating a display main body mounted to a supporting device according to an embodiment of the present general inventive concept;

FIG. 2 is a schematic view illustrating the supporting device in FIG. 1 according to an embodiment of the present general inventive concept;

FIGS. 3 and 4 are plan and side views to illustrate a folded state of the supporting device of FIG. 2;

FIGS. 5 to 7 are schematic views to illustrate an operation of the supporting device of FIG. 2; and

FIG. 8 is a schematic view illustrating the supporting device of FIG. 1 according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

A display apparatus according to the present general inventive concept may include a monitor, a television, a projector, and other known display apparatuses in the art. Hereinafter, embodiments of the present general inventive concept will be described with reference to a flat panel television, but it is understood that other known or later developed display apparatuses may also be used without departing from the principles and spirit of the present general inventive concept.

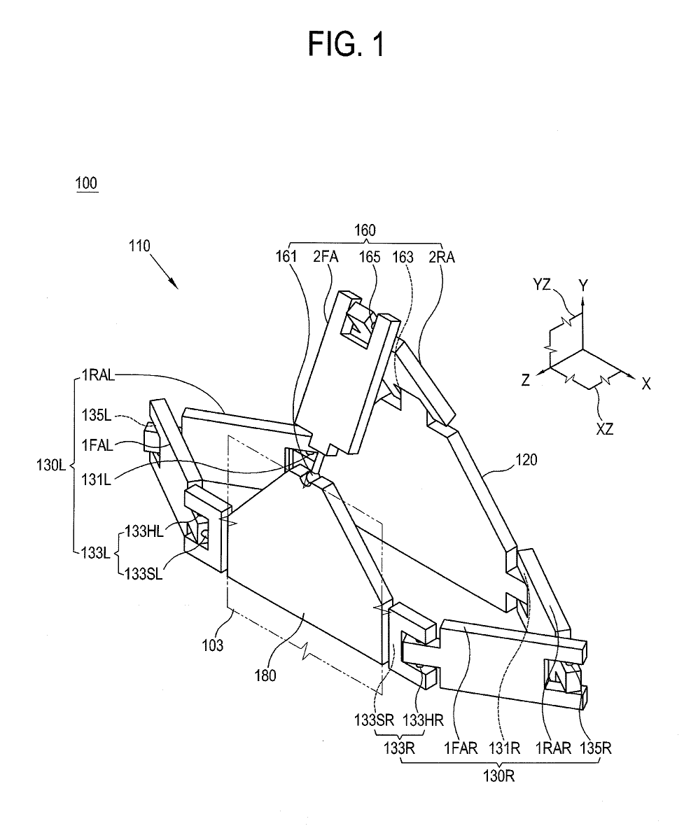

FIGS. 1 to 7 illustrate a supporting device 110 and a display apparatus 100 having the same according to an embodiment of the present general inventive concept. The supporting device 110 may include a stationary base 120, a first coupling unit 130, and a second coupling unit 160 including a rotation hinge 161. The display apparatus 100 may include a display main body 103 and the supporting device 110.

The stationary base 120 may be securely supported on an installation surface W, for example a wall or other supporting surface in a manner known in the art. To do so, the stationary base 120 may be directly coupled on the installation surface W, or may be coupled to a separate coupling bracket (not illustrated) provided to the installation surface W. The stationary base 120 may include a metal plate. Alternatively, the stationary base 120 may be configured to include a variety of other materials such as plastic or other suitable materials, as necessary.

The first coupling unit 130 may be coupled to the stationary base 120 and a moving base 180 to guide the moving base 180 to move with respect to the stationary base 120 along a first plane XZ. The first coupling unit 130 may include a left coupling unit 130L and a right coupling unit 130R.

In FIG. 1, the first plane XZ has been drawn to represent a plane substantially vertical to a second plane YZ. Here, it is understood that the first plane XZ may be the horizontal XZ plane including an X-axis and a Z-axis as illustrated in FIG. 1, or may be a vertical plane including a Y-axis and the Z-axis. However, for simplicity of description in the present disclosure, the first plane XZ will be defined as the horizontal plane, and the second plane YZ will be defined as the vertical plane.

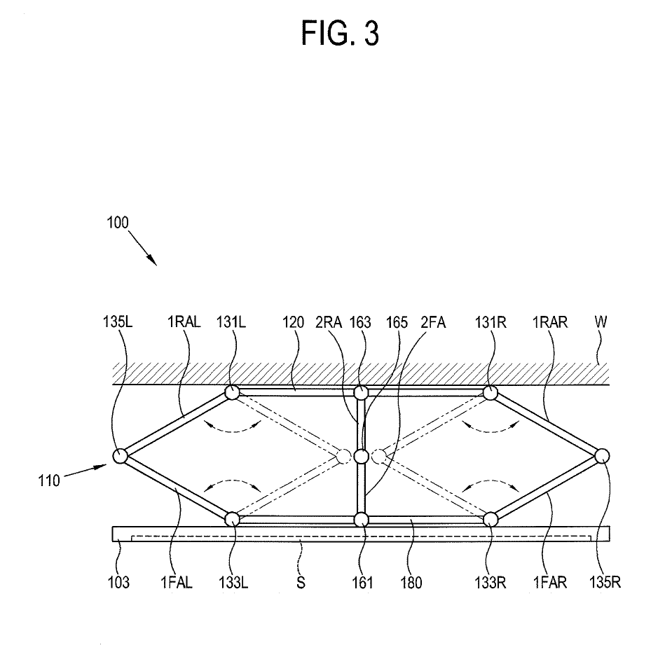

Also, although the first coupling unit 130 is illustrated to fold outwardly in FIG. 1, it is understood that the first coupling unit 130 may alternatively fold inwardly without departing from the principles and spirit of the present general inventive concept. For example, as illustrated in FIG. 3, the first coupling unit 130 may be changed from an outwardly folded state (illustrated by a solid line) to an inwardly folded state (illustrated by a dotted line) without departing from the principles and spirit of the present general inventive concept. The first coupling unit 130 may also be configured to fold both inwardly and outwardly.

Hereinafter, suffix ‘R’ in the reference numerals will represent right, and suffix ‘L’ will represent left. For example, in a first hinge 131, a first left hinge is referred to 131L, and a first right hinge is referred to 131R. However, the first left and right hinges may be commonly referred to 131 without the suffix as necessary.

The left coupling unit 130L and the right coupling unit 130R may be respectively coupled to left and right sides of the stationary base 120 and the moving base 180. The left coupling unit 130L and the right coupling unit 130R may respectively include the first hinge 131, a first joint 133 and a first central hinge 135.

A first side of the first hinge 131 may be coupled to the stationary base 120, and a second side thereof may be coupled to a first rear arm 1RA. The first hinge 131 may include a stationary member to inhibit inadvertent movement of the moving base 180 with respect to the stationary base 120, for example a friction member 137. A hinge configuration thereof may include a known pin 138, and a known pin accommodating hole 139 accommodating the pin 138. Accordingly, the first rear arm 1RA can pivotally rotate with respect to the stationary base 120 by means of the first hinge 131, and can maintain a rotated position by means of a friction force of the friction member 137.

The configuration of the each arm according to the present general inventive concept may comprise a planar shape to be coupled with the each hinge. Alternatively, the configuration of the each arm according to the present general inventive concept may comprise a variety of other shapes such as a circular rod shape, or other suitable shapes as necessary.

A first side of the first joint 133 may be coupled with the moving base 180, and a second side thereof may be coupled with a first front arm 1FA. The first joint 133 may include a joint hinge 133H and a joint pivot 133S. Accordingly, the moving base 180 can move in a right-and-left direction by means of the first joint 133, and the moving base 180 can rotate about the joint pivot 133S. That is, the first joint 133 can accomplish a function like a universal joint.

The first central hinge 135 may be interposed between the first hinge 131 and the first joint 133 to rotatably couple the first rear arm 1RA and the first front arm 1FA.

Accordingly, the moving base 180 can stably move along the first plane XZ by means of the first central hinge 135, the first hinge 131 and the first joint 133. That is, the moving base 180 can move and rotate in a forward-and-backward direction or the right-and-left direction.

The friction member 137 may be coupled to the first hinge 131 and a second hinge 163. That is, the friction member 137 may be coupled between the pin 138 and the pin accommodating hole 139 to generate a friction force while the first hinge 131 and the second hinge 163 rotate.

The friction force generated by the friction member 137 may have such strength as to prevent the supporting device 110 or the display main body 103 from moving or rotating by means of an external force which may be generated inadvertently, for example due to carelessness.

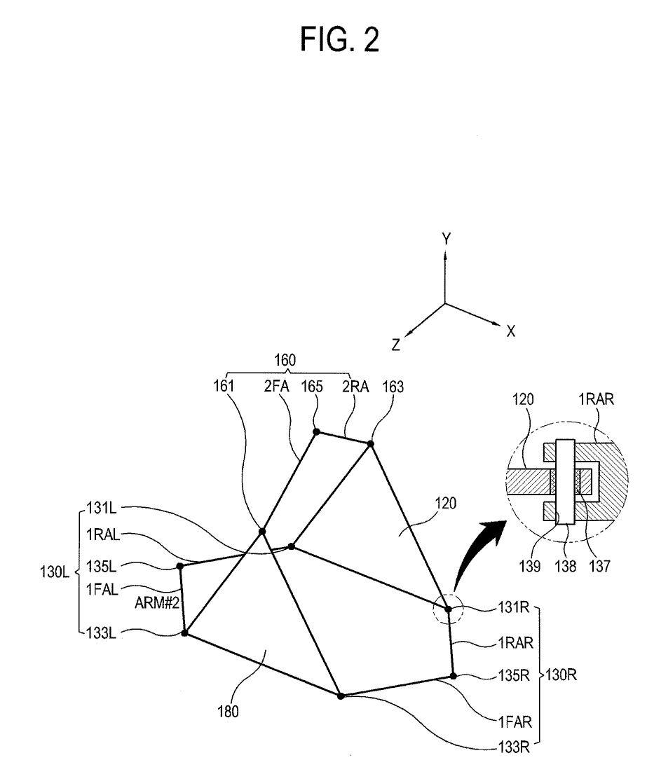

As illustrated in FIG. 2, the friction member 137 may also be provided to the first central hinge 135 and a second central hinge 165. That is, the friction member 137 may be provided only to the first hinge 131 and the second hinge 163, only to the first central hinge 135 and the second central hinge 165, or respectively to the first hinge 131, the second hinge 163, the first central hinge 135 and the second central hinge 165.

The friction member 137 may include a busing configuration as illustrated in FIG. 2. Alternatively, the friction member 137 may selectively employ various known members such as a friction spring.

Accordingly, a viewing angle of the display main body 103, in which the moving base 180 may be adjusted to have a predetermined angle, can be maintained by means of the friction member 137.

The second coupling unit 160 may couple the stationary base 120 and the moving base 180 so that the moving base 180 can be movably guided with respect to the stationary base 120 along the second plane YZ substantially vertical to the first plane XZ. The second coupling unit 160 may include a rotation hinge 161, a second hinge 163 and a second central hinge 165. The second coupling unit 160 may be coupled to upper parts of the stationary base 120 and the moving base 180. Alternatively, the second coupling unit 160 may be coupled to lower parts of the stationary base 120 and the moving base 180.

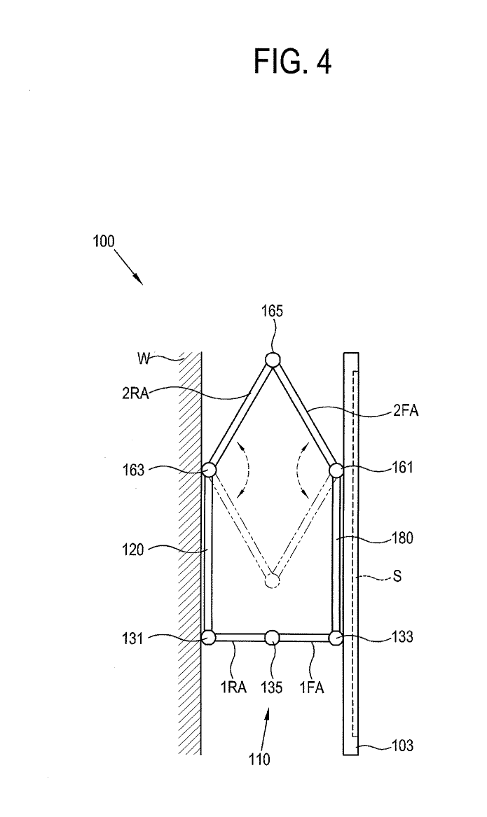

Also, as discussed above with respect to the first coupling unit 130, the second coupling unit 160 may be configured to fold outwardly as illustrated in FIG. 1. However, it is understood that the second coupling unit 160 may be alternatively configured to fold inwardly (not illustrated) without departing from the principles and spirit of the present general inventive concept. For example, as illustrated in FIG. 4, the second coupling unit 160 may be changed from an outwardly folded state (illustrated by a solid line) to an inwardly folded state (illustrated by a dotted line) without departing from the principles and spirit of the present general inventive concept. The second coupling unit 160 may also be configured to fold both inwardly and outwardly.

The rotation hinge 161 may rotatably support the moving base 180 along a transverse direction axis of the first plane. A first side of the rotation hinge 161 may be coupled with the moving base 180, and a second side thereof may be coupled with a second front arm 2FA.

The rotation hinge 161 may include a ball joint in accordance with an embodiment of the present general inventive concept, but it is understood that the rotation hinge 161 may alternatively include a universal joint similar to the first joint 133.

Accordingly, the viewing angle of the moving base 180 can be even further variously changed by means of the rotation hinge 161.

A first side of the second hinge 163 may be coupled with an upper part of the stationary base 120, and a second side thereof may be coupled with a second rear arm 2RA. Accordingly, the second rear arm 2RA can rotate with respect to the stationary base 120 by means of the second hinge 163.

The second central hinge 165 may be interposed between the second hinge 163 and the rotation hinge 161 to rotatably couple the second rear arm 2RA and the second front arm 2FA.

Accordingly, the moving base 180 can stably move along the second plane YZ by means of the second central hinge 165, the second hinge 163 and the rotation hinge 161. That is, the moving base 180 can move and rotate in the forward-and-backward direction or the right-and-left direction.

Here, as illustrated in FIGS. 3 and 4, the first coupling unit 130 and the second coupling unit 160 may be folded toward an outer part, or may be folded toward an inner part. That is, as illustrated in FIG. 3, the first coupling unit 130 may be changed from an outwardly folded state (illustrated by a solid line) to an inwardly folded state (illustrated by a dotted line). Also, as illustrated in FIG. 4, the second coupling unit 160 may be changed from an outwardly folded state (illustrated by a solid line) to an inwardly folded state (illustrated by a dotted line).

Accordingly, an external appearance of the display apparatus can be improved, and the accommodating space of the installation place can be efficiently utilized. Also, a coupling configuration can be rapidly changed to correspond to the position and configuration of a peripheral device, the type and quantity of a coupled signal line, or other configuration requirements.

The moving base 180 may cooperate with the stationary base 120 to support the display main body 103. The moving base 180 may be directly coupled with the display main body 103, or may be coupled with a stationary bracket (not illustrated) separately provided in the display main body 103. The moving base 180 may include a metal plate. Alternatively, the moving base 180 may be configured to include a variety of other materials such as plastic or other suitable materials, as necessary.

The display main body 103 forms a screen S, which may include a flat panel television, a monitor, a projector, and the like. The display main body 103 may be coupled directly and indirectly with the moving base 180 of the supporting device 110. Accordingly, a viewing angle to watch the screen S of the display main body 103 can be adjusted according to the movement and rotation of the moving base 180.

The screen S typically displays an image, for example from a display panel of the flat panel television, a screen of the monitor, etc.

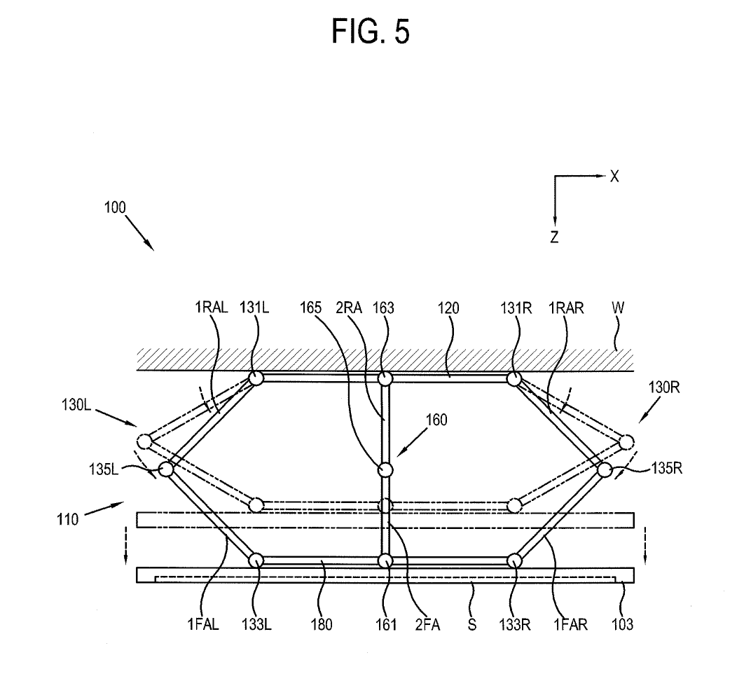

Hereinafter, an operating process of the display apparatus 100 according to an embodiment of the present general inventive concept will be described by referring to FIGS. 5 to 7.

First, with reference to FIG. 5, a process of moving the display main body 103 in the forward-and-backward direction will be described.

As illustrated in FIG. 5, a user may forwardly press the display main body 103 or the supporting device 110 to move the display main body 103 along the Z-axis as illustrated by the direction arrows in FIG. 5. Accordingly, the first coupling units 130L and 130R may be forwardly elongated in the Z-axis. That is, the first left and right rear arms 1RAL and 1RAR may respectively rotate counterclockwise and clockwise with respect to the stationary base 120 by means of first left and right hinges 131L and 131R as illustrated in FIG. 5, and the first left and right front arms 1FAL and 1FAR may respectively rotate clockwise and counterclockwise with respect to the first left and right rear arms 1RAL and 1RAR by means of first left and right central hinges 135L and 135R.

Also, the second coupling unit 160, which is upwardly elongated in the Y-axis before movement, becomes forwardly elongated in the Z-axis as the display main body 103 is moved along the Z-axis and away from the installation surface W, as illustrated by the direction arrows in FIG. 5. That is, the second rear arm 2RA may rotate clockwise with respect to the stationary base 120 by means of the second hinge 163 (when viewed from the left side), and the second front arm 2FA may rotate counterclockwise with respect to the second rear arm 2RA by means of the second central hinge 165 (when viewed from the left side).

Accordingly, as illustrated in FIG. 5, the moving base 180 may move in the Z-axis (from the dotted line portion to the solid line portion) so that the display main body 103 can move away from the installation surface W along the Z-axis. Of course, it is understood the display main body can also move toward the installation surface W along the Z-axis.

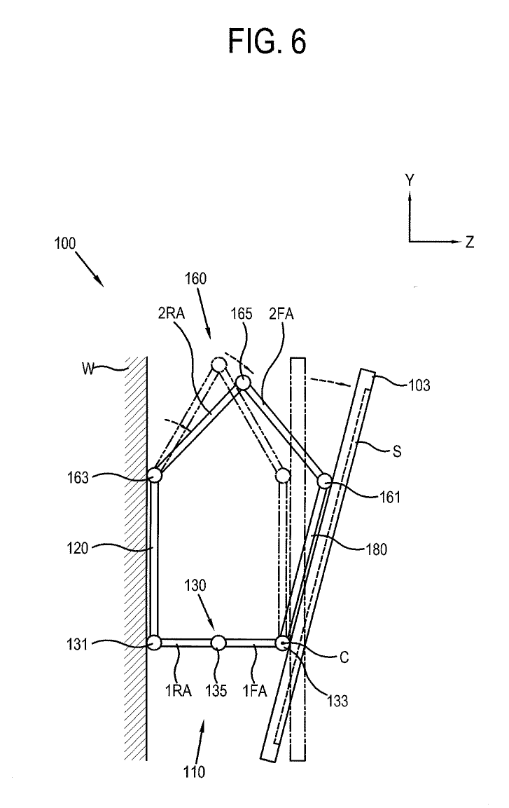

Referring now to FIG. 6, a process of rotating the display main body 103 about the X-axis, that is, in the upward and downward direction will be described.

As illustrated in FIG. 6, the user may press the top and/or bottom of the display main body 103 or the supporting device 110 to rotate the display main body 103 about the X-axis so as to adjust the viewing angle of the screen S in the upward-and-downward direction as illustrated by the direction arrows of FIG. 6. Here, the first coupling unit 130 may remain stationary, and the moving base 180 may tilt about a line connecting left and right joint pivots 133SL and 133SR of the first joint 133. That is, the second coupling unit 160 may be retracted or elongated about a central axis C, that is, the line connecting the left and right joint pivots 133SL and 133SR. In this way, the second coupling unit 160 may be forwardly elongated in the Z-axis. That is, the second rear arm 2RA may rotate clockwise (as indicated by the direction arrow) with respect to the stationary base 120 by means of the second hinge 163, and the second front arm 2FA may rotate counterclockwise with respect to the second rear arm 2RA by means of the second central hinge 165, as viewed from the perspective of FIG. 6.

Accordingly, as illustrated in FIG. 6, the moving base 180 may rotate from a dotted line portion to a solid line portion, and the display main body 103 may tilt in the downward direction about the X-axis. Of course, it is understood the display main body may also rotate in the upward direction about the X-axis.

As described herein, the user may press the display main body 103 or the supporting device 110 so that the operating processes illustrated in FIGS. 5 and 6 can be concurrently accomplished.

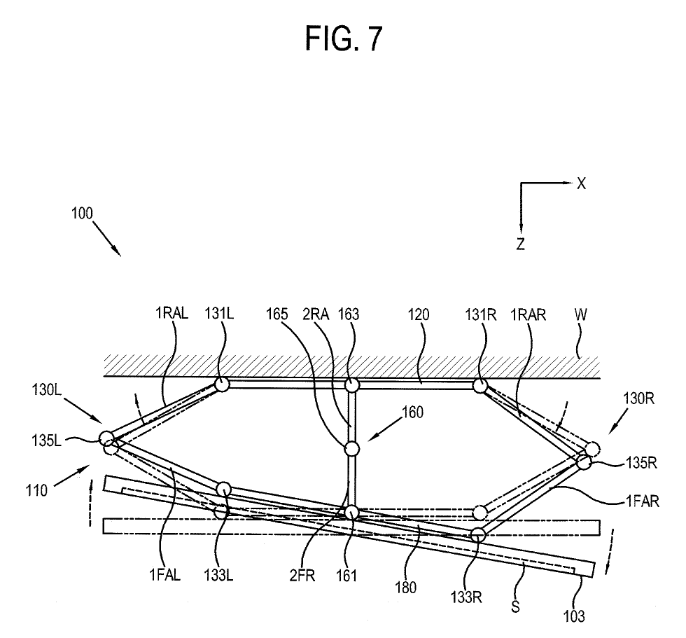

Referring now to FIG. 7, a process of rotating the display main body 103 about the Y-axis, that is, in the right-and-left direction will be described.

As illustrated in FIG. 7, the user may press the display main body 103 or the supporting device 110 to rotate the viewing angle of the display screen S about the Y-axis toward the left side as illustrated by the direction arrows of FIG. 7.

Here, the left coupling unit 130L may backwardly retract in the Z-axis as indicated by the direction arrow. That is, the first left rear arm 1RAL may rotate clockwise with respect to the stationary base 120 by means of the first left hinge 131L, and the first left front arm 1FAL may rotate counterclockwise with respect to the first left rear arm 1RAL by means of the first left central hinge 135L. On the other hand, the first right rear arm 1RAR may rotate clockwise with respect to the stationary base 120 by means of the right hinge 131R as indicated by the direction arrow, and the first right front arm 1FAR may rotate counterclockwise with respect to the first right rear arm 1RAR by means of the first right central hinge 135R.

Also, the second coupling unit 160 may remain stationary during this movement, and the moving base 180 may rotate about the rotation hinge 161.

Accordingly, as illustrated in FIG. 7, the display main body 103 may rotate in a left direction about the Y-axis so that the viewing angle of the screen S can be adjusted. Of course, it is understood that the display main body 103 may also rotate in a right direction about the Y-axis.

Here, the user may press the display main body 103 or the supporting device 110 so that the operating processes illustrated in FIGS. 5 to 7 can be concurrently accomplished.

Accordingly, the user can more simply and conveniently adjust the viewing angle of the screen S of the display main body 103. Also, since the display main body 103 may be conveniently moved forwardly by means of the first coupling unit 130 and the second coupling unit 160, a space between the installation surface W and the display main body 103 can be easily obtained to conveniently accomplish work therebetween. Accordingly, a peripheral device can be simply mounted to and detached from the display main body 103, and various peripheral devices can be rapidly and conveniently applied thereto. Also, the supporting device 110 can be folded to achieve a slimmed profile and to improve the external appearance thereof as necessary.

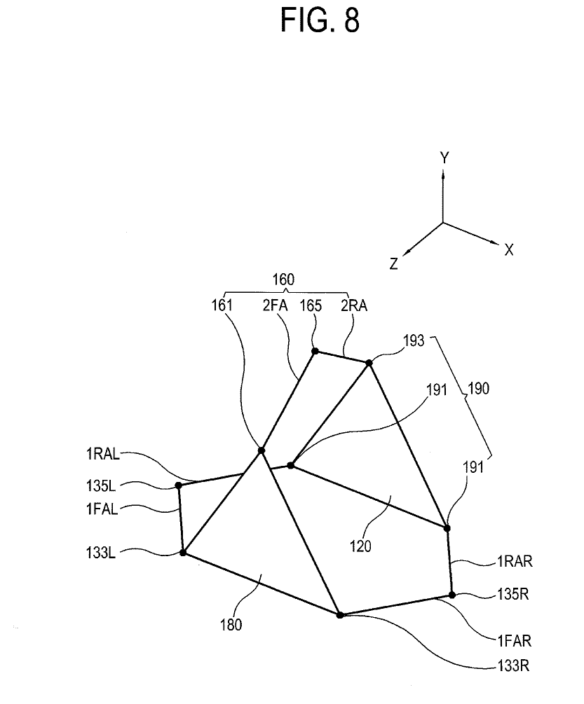

A supporting device 110 and a display apparatus 100 having the same according to another embodiment of the present general inventive concept are illustrated in FIG. 8. Here, the supporting device 110 may include a driving hinge 190 which is electrically driven. As illustrated in FIG. 8, the driving hinge 190 may include a first driving hinge 191 and a second driving hinge 193. The first driving hinge 191 and the second driving hinge 193 may include a driving means such as a motor of a type known in the art. Accordingly, if a first rear arm 1RA and a second rear arm 2RA are driven by means of the driving means of the first driving hinge 191 and the second driving hinge 193, a first central hinge 135, a second central hinge 165, a first joint 133 and a rotation hinge 161 may be driven in sequence so that the moving base 180 can move.

The driving hinge 190 may also be provided to the first central hinge 135 and the second central hinge 165. That is, the driving hinge 190 may be provided only to a first hinge 131 and a second hinge 163, only to the first central hinge 135 and the second central hinge 165, or respectively to the first hinge 131, the second hinge 163, the first central hinge 135 and the second central hinge 165.

Here, a user may operate the driving hinge 190 by a controlling means including a remote controller (not illustrated).

For example, a case for tilting forwardly a screen S of a display main body 103 will be described. The user may drive the second driving hinge 193 by the controlling means such as the remote controller and/or other known controller so that a second rear arm 2RA can rotate clockwise with respect to a stationary base 120 (when viewed from the left side). Accordingly, a second coupling unit 160 may be elongated so that an upper part of the moving base 180 can forwardly rotate about a central axis connecting left and right joint pivots 133SL and 133SR. Accordingly, the screen S of the display main body 103 can tilt forwardly.

Remaining operating processes according to this another embodiment of the present general inventive concept may include the same or similar processes described above with respect to the other embodiments of the present general inventive concept, and a detailed description thereof will not be repeated herein.

Accordingly, in this another embodiment of the present general inventive concept, a viewing angle of the screen S of the display main body 103 can be even further conveniently and rapidly adjusted.

As described herein, the present general inventive concept provides a supporting device and a display apparatus having the same to more conveniently adjust a viewing angle of the display apparatus.

Also, the present general inventive concept provides a supporting device and a display apparatus having the same to simplify a connection with a peripheral device, and to rapidly change a connection configuration.

Also, the present general inventive concept provides a supporting device and a display apparatus having the same to improve an external appearance of the display apparatus and to improve space utilization of the installation place.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A supporting device, comprising:
a stationary base;
a moving base to cooperate with the stationary base;
a first coupling unit coupled to the stationary base and the moving base to guide the moving base to move with respect to the stationary base along a first plane; and
a second coupling unit coupled to the stationary base and the moving base to movably guide the moving base with respect to the stationary base along a second plane substantially vertical to the first plane, the second coupling unit comprising a rotation hinge to rotatably guide the moving base along a transverse direction axis of the first plane.

2. The supporting device of claim 1, wherein the first coupling unit and the second coupling unit are folded in one of an inward direction and an outward direction.

3. The supporting device of claim 1, wherein at least one of the first coupling unit and the second coupling unit is capable of being folded inwardly and outwardly.

4. The supporting device of claim 1, wherein the first plane comprises one of a horizontal plane and a vertical plane, and the second plane comprises the other of the horizontal plane and the vertical plane.

5. The supporting device of claim 1, wherein the first coupling unit comprises:
a left coupling unit coupled to first sides of the stationary base and the moving base; and
a right coupling unit coupled to second sides of the stationary base and the moving base.

6. The supporting device of claim 5, wherein the left coupling unit and the right coupling unit respectively comprise:
a first hinge coupled to the stationary base;
a first joint coupled to the moving base; and
a first central hinge interposed between the first hinge and the first joint.

7. The supporting device of claim 6, wherein the rotation hinge is coupled to the moving base, and
the second coupling unit comprises a second hinge coupled to the stationary base, and a second central hinge interposed between the rotation hinge and the second hinge.

8. The supporting device of claim 7, wherein at least one of the first hinge, the first central hinge, the second hinge and the second central hinge further comprise a friction member to inhibit inadvertent movement of the moving base with respect to the stationary base.

9. The supporting device of claim 7, wherein at least one of the first hinge, the first central hinge, the second hinge and the second central hinge are electrically driven.

10. The supporting device of claim 1, wherein the rotation hinge comprises one of a ball joint and a universal joint.

11. A display apparatus, comprising:
a display main body; and
a supporting device coupled to the display main body to support the display main body,
wherein the supporting device comprises:
a stationary base;
a moving base to cooperate with the stationary base;
a first coupling unit coupled to the stationary base and the moving base to guide the moving base to move with respect to the stationary base along a first plane; and
a second coupling unit coupled to the stationary base and the moving base to movably guide the moving base with respect to the stationary base along a second plane substantially vertical to the first plane, the second coupling unit comprising a rotation hinge to rotatably guide the moving base along a transverse direction axis of the first plane.

12. A supporting device, comprising:
a stationary base to mount to an installation surface;
a moving base to mount to a display screen;
a first coupling unit having left and right hinge arrangements coupled between the stationary base and the moving base to guide the display screen along a transverse axis with respect to the installation surface, and to pivot the display screen about a vertical axis substantially perpendicular to the transverse axis; and
a second coupling unit having another hinge arrangement coupled between the stationary base and the moving base to pivot the display screen about a horizontal axis substantially perpendicular to the transverse axis.

13. The supporting device of claim 12, wherein the first and second coupling units can be adjusted concurrently or independently to adjust a viewing angle of the display screen.

14. The supporting device of claim 12, further comprising:
a workspace disposed between the stationary base and the moving base to allow a user to change a connection configuration of an external device connected to the display screen.

15. The supporting device of claim 12, further comprising:
a driving unit to drive the first and second coupling units to adjust a viewing angle of the display screen.

16. The supporting device of claim 15, wherein the driving unit includes an electric motor under the control of a controller to electronically adjust the viewing angle of the display screen.

17. A supporting device, comprising:
a first base supportable to a stationary surface;
a second base supportable to a display unit; and
a coupling system connecting the first and second base such that the second base can rotate about two axes orthogonal to each other and can move along a third axis orthogonal to both the first and second axes.

18. The supporting device of claim 17, wherein the coupling system comprises:
a first coupling unit to rotate the second base about one of the two rotatable orthogonal axes, and to move the second base along the third orthogonal axis; and
a second coupling unit to rotate the second base about the other rotatable orthogonal axis.

19. The supporting device of claim 18, wherein the first coupling unit comprises a pair of hinge arrangements disposed on opposite sides of the first and second bases, respectively, and the second coupling unit comprises a hinge arrangement disposed on a top or bottom surface of the first and second bases.

20. The supporting device of claim 19, wherein at least one of the hinge arrangements comprises a stationary member to maintain a position of the second base with respect to the first base.
